(19) United States
(12) Patent Application Publication
(10) Pub. No.: US 2026/0084689 A1
(43) Pub. Date: Mar. 26, 2026

(54) CONTROL DEVICE FOR HYBRID ELECTRIC VEHICLE

(71) Applicant: TOYOTA JIDOSHA KABUSHIKI KAISHA, Toyota-shi (JP)

(72) Inventor: Hidekazu NAWATA, Gotemba-shi (JP)

(73) Assignee: TOYOTA JIDOSHA KABUSHIKI KAISHA, Toyota-shi (JP)

(21) Appl. No.: 19/198,214

(22) Filed: May 5, 2025

(30) Foreign Application Priority Data
Sep. 24, 2024 (JP) 2024-164824

(51) Int. Cl. B60W 20/40; B60W 10/06; B60W 10/08; B60W 20/13; B60W 20/16

(52) U.S. Cl. CPC B60W 20/40; B60W 10/06; B60W 10/08; B60W 20/13; B60W 20/16; B60W 2510/068; B60W 2510/244

(57) ABSTRACT

A control device for a hybrid electric vehicle including two types of drive sources of a motor and an engine includes a processing circuit that performs a switching process for switching an EV mode in which the motor is driven only by the output of the motor and HV mode in which the output of the engine can be used as the traveling power, a setting process for setting an upper limit value of the traveling power so as to have a value smaller than that in HV mode in EV mode, and a process circuit for performing a holding process for holding the upper limit value of the traveling power at the value in EV mode for a period from when the switching process from EV mode to HV mode is performed until when the catalytic warm-up of the engine is completed.

### CROSS-REFERENCE TO RELATED APPLICATION

This application claims priority to Japanese Patent Application No. 2024-164824 filed on Sep. 24, 2024. The disclosure of the above-identified application, including the specification, drawings, and claims, is incorporated by reference herein in its entirety.

### BACKGROUND

### 1. Technical Field

The present disclosure relates to a control device for a hybrid electric vehicle.

### 2. Description of Related Art

As a control device for a hybrid electric vehicle, there is a device that switches an electric traveling mode and a hybrid traveling mode depending on a traveling state, a charging state of a battery, etc. The electric traveling mode is a traveling mode in which the vehicle travels using only power of a motor. The hybrid traveling mode is a traveling mode in which engine power can be used as traveling power.

Hitherto, a device described in Japanese Unexamined Patent Application Publication No. 2013-133040 (JP 2013-133040 A) is known as the control device for a hybrid electric vehicle that switches the traveling modes. The control device limits the output of the engine during a period from the switching from the electric traveling mode to the hybrid traveling mode to the completion of warm-up of the engine.

### SUMMARY

A maximum driving force that is the maximum value of the power available for traveling varies depending on the traveling mode. In the hybrid traveling mode in which the power of both the motor and the engine can be used, the maximum driving force is larger than that in the electric traveling mode in which only the power of the motor can be used. Therefore, the traveling characteristic of the hybrid electric vehicle changes in response to the switching of the traveling modes.

The above related-art control device limits the output of the engine when the electric traveling mode is switched to the hybrid traveling mode while the engine is not warmed up. Since the engine power can be used for traveling within the limited range even during the output limit, the maximum driving force is larger than that in the electric traveling mode. When the output limit is terminated, the maximum driving force further increases. Therefore, when the electric traveling mode is switched to the hybrid traveling mode while the engine is not warmed up, the traveling characteristic of the hybrid electric vehicle changes twice. In this case, the driver may feel uncomfortable because the traveling characteristic changes twice during one switching of the traveling modes.

A control device for a hybrid electric vehicle that solves the above problem is a control device for a hybrid electric vehicle including two drive sources that are a motor and an engine. The control device includes a processing circuit configured to perform:
a switching process for switching an electric traveling mode in which traveling is performed using only output of the motor and a hybrid traveling mode in which output of the engine is usable as traveling power;
a setting process for setting, in the electric traveling mode, an upper limit value of the traveling power to a value smaller than an upper limit value in the hybrid traveling mode; and
a keeping process for keeping the upper limit value of the traveling power at the value in the electric traveling mode during a period from the switching from the electric traveling mode to the hybrid traveling mode by the switching process to completion of catalyst warm-up of the engine.

The control device for the hybrid electric vehicle is effective in suppressing deterioration of both emission and drivability during the switching of the traveling modes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an embodiment of a control device of a hybrid electric vehicle;

FIG. 2 is a flowchart of processing executed by the control device of FIG. 1 for setting the upper limit required power;

FIG. 3 is a time chart in a case where a comparative example of the control device that sets the upper limit required power without performing the holding process performs the switching of the traveling mode. Graph (a) shows the transition of the charge level of the battery, graph (b) shows the transition of the traveling mode, graph (c) shows the transition of the driver required power, respectively. In addition, the graph (d) represents the transition of the motor required output, the graph (e) represents the transition of the engine required output, and the graph (f) represents the transition of the catalytic temperature; and

FIG. 4 is a time chart in a case where the control device of FIG. 1 switches the traveling mode. Graph (a) shows the transition of the charge level of the battery, graph (b) shows the transition of the traveling mode, graph (c) shows the transition of the driver required power, respectively. The graph (d) shows the transition of the motor required output, the graph (e) shows the transition of the engine required output, and the graph (f) shows the transition of the catalyst temperature.

### DETAILED DESCRIPTION OF EMBODIMENTS

### Configuration of Hybrid Electric Vehicle Control Device

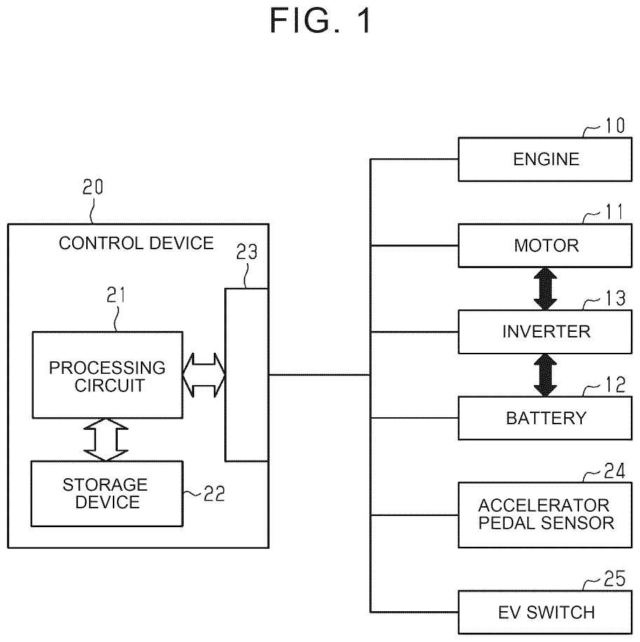

An embodiment of a control device for a hybrid electric vehicle will now be described with respect to FIG. 1 to FIG. 4.

First, the configuration of the present embodiment will be described with reference to FIG. 1. Hybrid electric vehicle employing the control device 20 of the present embodiment includes two types of drive sources, namely, an engine 10 and a motor 11, as drive sources for traveling. The motor 11 generates power by power supply from the battery 12. The motor 11 and the battery 12 are electrically connected to each other via an inverter 13. The inverter 13 regulates the electric power supplied by the battery 12 to the motor 11. Hybrid electric vehicle of the present embodiment is configured as a plug-in type hybrid electric vehicle capable of externally charging the battery 12. Various sensors for detecting the state of the engine 10, the motor 11, and the battery 12 are installed respectively.

The control device 20 includes a processing circuit 21, a storage device 22, and a I/O module 23. The storage device 22 stores programs and data used for vehicle control. The processing circuit 21 executes a program read from the storage device 22 to perform various kinds of processing for vehicle control. The processing circuit 21 is connected to the engine 10, the motor 11, the battery 12, and the inverter 13 via I/O module 23. The processing circuit 21 acquires detection results of various sensors installed in the engine 10, the motor 11, and the battery 12. For example, the processing circuit 21 acquires, from the engine 10, a quantity of intake air, an engine rotational velocity NE, an engine water temperature, and the like. The processing circuit 21 acquires detection results such as motor rotational speed NMG and motor torque from the motor 11, and detection results such as charge level SOC and battery temperature from the battery 12. Further, I/O module 23 is also connected with a sensor installed in a part other than the engine 10, the motor 11, and the battery 12 of hybrid electric vehicle such as the accelerator pedal sensor 24. The accelerator pedal sensor 24 is a sensor that detects an accelerator operation amount ACCP that is an operation amount of the accelerator pedal of the driver. The processing circuit 21 also acquires the detection results of these sensors.

The processing circuit 21 controls the output of the engine 10 and the motor 11 based on the detection results of the sensors. Specifically, the processing circuit 21 controls the output of the engine 10 by operating the throttle opening degree, the fuel injection amount, the ignition timing, and the like of the engine 10. The processing circuit 21 controls the output of the motor 11 by operating the inverter 13 to adjust the electric power supplied to the motor 11 by the battery 12.

### Switching Process of the Traveling Mode

In a hybrid electric vehicle where the control device 20 of the present embodiment is employed, two traveling modes, an electric traveling mode and a hybrid traveling mode, are set. The electric traveling mode is a traveling mode in which the vehicle travels only by the output of the motor 11, and the hybrid traveling mode is a traveling mode in which the output of the engine 10 can be used as the traveling power. The processing circuit 21 stops the engine 10 in the electric traveling mode. In addition, the processing circuit 21 performs the automatic stopping and the automatic restarting of the engine 10 in accordance with the running state of hybrid electric vehicle and the charge level SOC of the battery 12 in the hybrid traveling mode. In the following explanation, the electric traveling mode is referred to as an EV mode. In the following explanation, the hybrid traveling mode is referred to as an HV mode.

The processing circuit 21 determines the traveling mode based on the operating condition of EV switch 25 in which hybrid electric vehicle is installed, the charge level SOC of the battery 12, and the like. EV switch 25 is a switch operated by the driver to select the traveling mode. Processing circuit 21 selects EV when EV switch 25 is on and the charge level SOC of the battery 12 is equal to or greater than the predetermined EV traveling permission determination value S0. When EV switch 25 is off or the charge level SOC of the battery 12 is less than EV traveling permission determination value S0, the processing circuit 21 selects HV mode. Therefore, the switching of the traveling mode from EV mode to HV mode occurs in any of the following situations 1 and 2. Situation 1 is when the driver turns off EV switch 25. Situation 2 is when the charge level SOC of the battery 12 falls below EV traveling permission determination value S0. The situation 2 is generated by the driver's operation, whereas the situation 1 is generated irrespective of the driver's operation. In the following description, the switching of the traveling mode according to the situation 1 is referred to as manual switching, and the switching of the traveling mode according to the situation 2 is referred to as automatic switching.

### Setting the Upper Limit Required Power

During traveling of hybrid electric vehicle, the processing circuit 21 calculates a driver required power PW*, which is a required value of the driving force of hybrid electric vehicle, based on the accelerator operation amount ACCP and the like. When calculating the driver required power PW*, the processing circuit 21 performs the upper limit guard of the driver required power PW* so as to be equal to or less than the value of the upper limit required power PWLM. The processing circuit 21 then sets the engine required output PE and the motor required output PMG such that their sum equals the driver required power PW*. The engine required output PE is a required value of the output generated by the engine 10, and the motor required output PMG is a required value of the output generated by the motor 11. Then, the processing circuit 21 controls the output of the engine 10 in accordance with the engine required output PE and controls the output of the motor 11 in accordance with the motor required output PMG. In EV mode, the processing circuit 21 sets “0” as the engine required output PE.

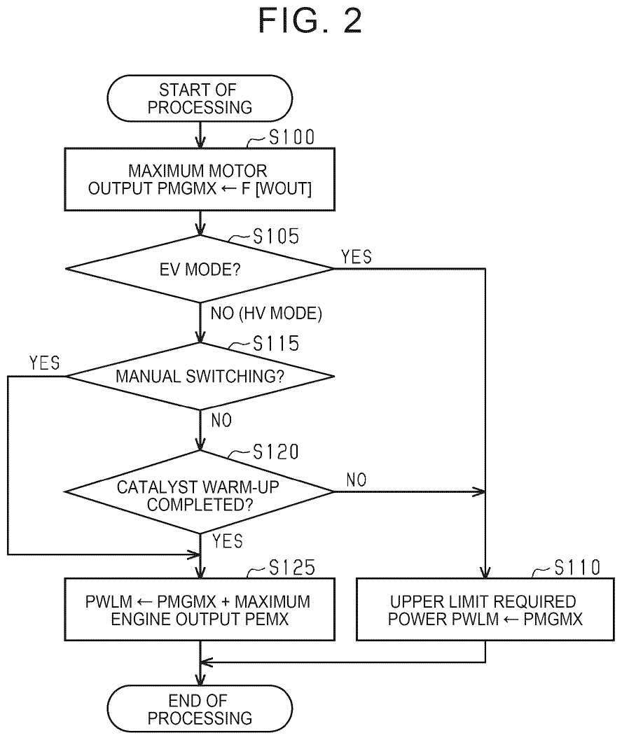

FIG. 2 shows a flow chart of processing executed by the processing circuit 21 for setting the upper limit required power PWLM. During traveling of hybrid electric vehicle, the processing circuit 21 repeatedly executes the processing of FIG. 2 at predetermined control cycles.

When this processing is started, the processing circuit 21 first calculates the maximum motor output PMGMX in S100. Maximum motor output PMGMX means the upper limit value of the motor output. In the present embodiment, the processing circuit 21 calculates the maximum motor output PMGMX based on the battery discharge amount WOUT. The battery discharge amount WOUT represents an upper limit value of electric power that the battery 12 can supply to the motor 11. In the present embodiment, the processing circuit 21 determines the battery discharge amount WOUT based on the charge level SOC and the temperature of the battery 12.

In the following S105, the processing circuit 21 determines whether or not the present traveling mode is EV mode. Then, the processing circuit 21 advances the processing to S110 when it is determined that the present traveling mode is EV mode (YES), and to S115 when it is determined that the present traveling mode is not EV mode (NO). In the present embodiment, HV mode is set to hybrid electric vehicle traveling mode when the processing circuit 21 makes a negative determination in S105.

In S110, the processing circuit 21 sets the value of the maximum motor output PMGMX calculated by S100 as the value of the upper limit required power PWLM. After S110, the processing circuit 21 ends the processing of FIG. 2 in the current control cycle.

On the other hand, in S115, the processing circuit 21 determines whether or not the switching of the traveling mode to the currently set HV mode is the manual switching. The processing circuit 21 advances the processing to S125 when it is determined that the manual switching is performed (YES), and to S120 when it is determined that the manual switching is not performed, that is, when it is determined that the automatic switching is performed (NO).

In S120, the processing circuit 21 determines whether the catalytic warm-up of the engine 10 is completed. In the case of the present embodiment, the processing circuit 21 determines that the catalyst warm-up is completed when the catalyst temperature of the engine 10 rises above the active temperature of the catalyst. Then, the processing circuit 21 advances the processing to S125 when it is determined that the catalytic warm-up is completed (YES), and to S110 when it is determined that the catalytic warm-up is not completed (NO).

In S125, the processing circuit 21 adds the maximum motor output PMGMX and the maximum engine output PEMX, and sets the added value as the value of the upper limit required power PWLM. The maximum engine output PEMX represents an upper limit value of the output that the engine 10 can generate. After S125, the processing circuit 21 ends the processing of FIG. 2 in the current control cycle.

### Operation of the Embodiment

Processing circuit 21 performs a switching process of switching EV mode to run only by the output of the motor 11, and HV mode to switch the output of the engine 10 in addition to the motor 11 as traveling power. In the switching from EV mode to HV mode by the switching process, there are a manual switching performed in accordance with a manual operation by the driver and an automated switching performed automatically instead of the manual operation. For example, the auto-switching is performed when the charge level SOC of the battery 12 that supplies electric power to the motor 11 becomes less than a predetermined value (EV traveling permission determination value S0).

Further, the processing circuit 21 performs a setting processing for setting an upper limit required power PWLM which is an upper limit value of the traveling power. In the setting process, the processing circuit 21 basically sets the value of the upper limit required power PWLM so as to have a value smaller than that in HV mode in EV mode. Specifically, in EV mode, the processing circuit 21 sets the maximum motor output PMGMX, which is the maximum value of the output that can be generated by the motor 11, as the value of the upper limit required power PWLM (S110 in FIG. 2). In HV mode, the processing circuit 21 sets the sum of the maximum motor output PMGMX and the maximum engine output PEMX, which is the maximum value of the output that can be generated by the engine 10, as the value of the upper limit required power PWLM (S125 in FIG. 2).

However, even in HV mode, when the following requirements (1) and (2) are satisfied, the processing circuit 21 sets the maximum motor output PMGMX as the upper limit required power PWLM in the same manner as in EV mode. The requirement (1) is a requirement that the catalytic warm-up of the engine 10 is not completed (in S120: NO of FIG. 2). Requirement (2) is a requirement that the switching to the present HV mode is an auto-switching (S115: NO of FIG. 2). As described above, the processing circuit 21 performs the holding processing for holding the value of the upper limit required power PWLM at the value in EV mode for a period from when EV mode is automatically switched to HV traveling mode until the catalytic warm-up of the engine 10 is completed. Such a holding process is performed for the purpose of suppressing deterioration of both emission and drivability at the time of switching the traveling mode.

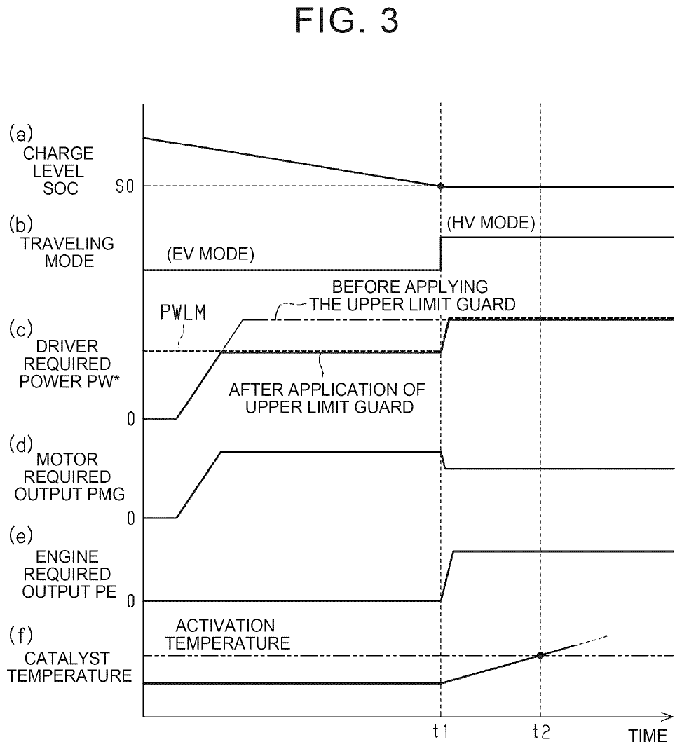

FIG. 3 shows an exemplary control mode of hybrid electric vehicle at the time of switching the traveling mode when the upper limit required power PWLM is set without performing the holding process. The graph (a) of FIG. 3 shows the transition of the charge level SOC of the battery 12, the graph (b) of FIG. 3 shows the transition of the traveling mode, and the graph (c) of FIG. 3 shows the transition of the driver required power PW*. The graph (d) of FIG. 3 shows the transition of the motor required output PMG, the graph (e) of FIG. 3 shows the transition of the engine required output PE, and the graph (f) of FIG. 3 shows the transition of the catalytic temperature. In the graph (c) of FIG. 3, the transition of the value of the driver required power PW* before the application of the upper limit guard by the upper limit required power PWLM is indicated by a two-dot chain line, and the transition of the value of the driver required power PW* after the application is indicated by a solid line.

In FIG. 3, at the time t1 during traveling in EV mode, the charge level SOC of the battery 12 decreases to less than EV traveling permission determination value S0, and auto-switching to HV mode is performed. The processing circuit 21 starts the engine 10 at time t1.

The driver required power PW* at the time of time t1 exceeds the maximum motor output PMGMX prior to application of the upper limit guard. As described above, in EV mode, the maximum motor output PMGMX is set as the upper limit required power PWLM. Therefore, the final driver required power PW* after the application of the upper limit guard at this time is set to be equal to the maximum motor output PMGMX. In FIG. 3, even after the time t1, the value of the driver required power PW* prior to the application of the upper limit guard is maintained at the value at the time point t1.

When the holding process is not performed, the value of the upper limit required power PWLM is switched from the value in EV mode to the value in HV mode at the time of the time t1. Therefore, when the holding process is not performed, the engine 10 may be operated with a large output immediately after starting. In FIG. 3, the catalytic temperature at the time t1 when the engine 10 is started in response to the switching to HV mode is lower than the activation temperature. Therefore, the engine 10 cannot sufficiently purify the exhaust gas until the catalyst temperature reaches the active temperature and the catalyst warm-up is completed t2 the subsequent time. Thus, when the holding process is not performed, there is a possibility that the engine 10 is operated with a large output in a state where the catalyst warm-up is incomplete. Therefore, emission may deteriorate during switching of traveling modes.

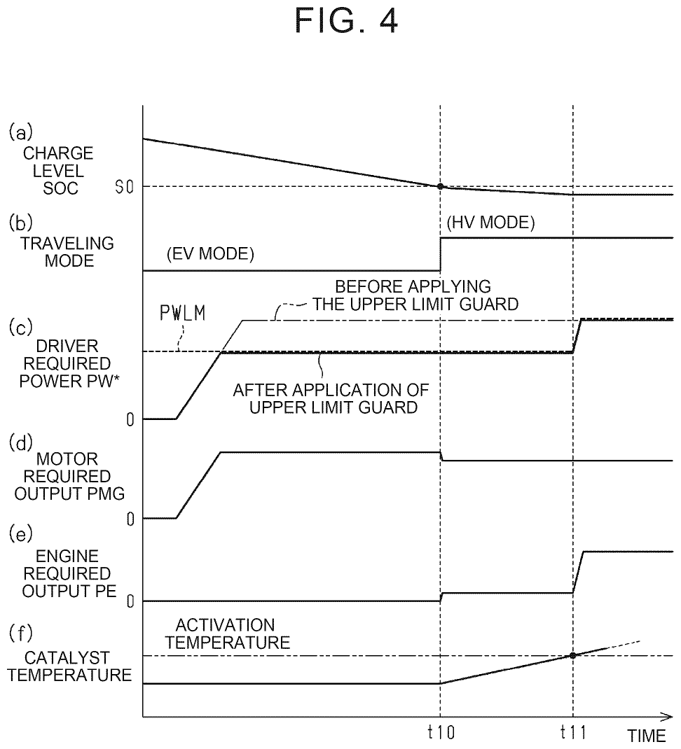

FIG. 4 shows an exemplary control mode of hybrid electric vehicle at the time of switching the traveling mode according to the present embodiment. The graph (a) of FIG. 4 shows the transition of the charge level SOC of the battery 12, the graph (b) of FIG. 4 shows the transition of the traveling mode, and the graph (c) of FIG. 4 shows the transition of the driver required power PW*. The graph (d) of FIG. 4 shows the transition of the motor required output PMG, the graph (e) of FIG. 4 shows the transition of the engine required output PE, and the graph (f) of FIG. 4 shows the transition of the catalytic temperature. In the graph (c) of FIG. 4, the transition of the value of the driver required power PW* before the application of the upper limit guard by the upper limit required power PWLM is indicated by a two-dot chain line, and the transition of the value of the driver required power PW* after the application is indicated by a solid line.

Also in the case of FIG. 4, as in the case of FIG. 3, the charge level SOC of the battery 12 is reduced to less than the EV traveling permission determination value S0 and the mode is automatically switched to HV mode at time t10 during traveling in EV mode. The processing circuit 21 starts the engine 10 at time t10. Also in FIG. 4, the time t10 and the driver required power PW* thereafter exceed the maximum motor output PMGMX prior to the application of the upper limit guard.

In the present embodiment, even after switching to HV mode, the upper limit required power PWLM is maintained at the value in EV mode until the catalyst temperature becomes equal to or higher than the activation temperature and the catalyst warm-up of the engine 10 is completed at the time t11. More specifically, during the period from the start of the engine 10 to the completion of the catalyst warm-up by switching to HV mode, the driver required power PW* is held at or below the maximum motor output PMGMX. Therefore, the output of the engine 10 is suppressed until the catalyst warm-up is completed. Even if the catalyst warm-up is incomplete, if the engine 10 has a low output, the exhaust flow rate is small, so that the deterioration of the emission is limited. In addition, the upper limit required power PWLM is maintained at EV time until the completion of the catalytic warm-up. Therefore, the change in the traveling characteristic of hybrid electric vehicle due to the change in the upper limit required power PWLM occurs only when the catalytic warm-up is completed.

When a large driving force that cannot be generated in EV mode is required, the driver performs manual switching to HV mode. On the other hand, the processing circuit 21 is configured to perform the holding processing only in the case of the automatic switching among the manual switching and the automatic switching. Therefore, in the case of manual switching, the value of the upper limit required power PWLM is changed from the value in EV mode to the value in HV mode together with the switching from EV mode to HV mode. Therefore, the driving force of hybrid electric vehicle can be rapidly increased in response to the driver's demand.

### Effect of the Embodiment

The control device 20 of hybrid electric vehicle of the present embodiment has the following advantages.

(1) The control device 20 of hybrid electric vehicle of the present embodiment includes a processing circuit 21 that performs the switching processing, the setting processing, and the holding processing described below. The switching process is a process of switching between EV mode in which the motor 11 travels only at the output and HV mode in which the output of the engine 10 can be used as the traveling power. The setting process is a process of setting the value of the upper limit required power PWLM which is the upper limit value of the traveling power so as to be smaller in EV mode than in HV mode. The holding process is a process of holding the upper limit required power PWLM to the value in EV mode for a period from when EV mode is switched to HV mode by the switching process until the catalytic warm-up of the engine 10 is completed. After switching from EV mode to HV mode, the low-power operation of the engine 10 can be maintained until the catalytic warm-up of the engine 10 is completed. In addition, the change in the traveling characteristic due to the change in the upper limit required power PWLM is kept only once at the time of completion of the catalytic warm-up. Therefore, deterioration of both emission and drivability at the time of switching the traveling mode can be suppressed.

(2) The processing circuit 21 is configured to perform the holding processing only in the case of automatic switching among manual switching and automatic switching. Therefore, it is possible to generate the driving force corresponding to the request at the time of manual switching in which the driver requests an increase in the driving force, but it is possible to suppress the deterioration of the emission at the time of automatic switching in which the driving force is not increased.

(3) In the switching process, the processing circuit 21 is configured to perform the auto-switching when the charge level SOC of the battery 12 that supplies electric power to the motor 11 becomes less than a predetermined value. Therefore, it is possible to continue traveling in EV mode as long as insufficient charge of the battery 12 does not occur.

(4) In the setting process, the processing circuit 21 is configured to set the upper limit required power PWLM in EV mode in accordance with the charge level SOC of the battery 12 that supplies electric power to the motor 11. In such cases, the driver required power PW* during the time period in which the value of the upper limit required power PWLM is held at the value in EV mode by the holding process is maintained at a value that can be satisfied only by the output of the motor 11. Therefore, it is possible to set the output of the engine 10 to an arbitrary value during a period until the catalyst warm-up is completed. Therefore, the power of the engine 10 during the period from the switching of HV mode to the completion of the catalyst warm-up can be set to an appropriate value for suppressing the deterioration of the emission.

### Other Embodiments

The present embodiment can be modified and implemented as follows. The present embodiment and the following modifications can be combined unless technical inconsistency arises.
The setting of the upper limit required power PWLM in the setting process may be performed in a manner that differs from the above-described embodiment as long as the value in EV mode becomes a value smaller than the value in HV mode.
Automatic switching from EV mode to HV mode and manual switching may be performed differently from the above embodiments. For example, the processing circuit 21 may be configured to automatically switch to HV mode when a large driving force exceeding the power limit of the motor 11 is required during traveling in EV mode.
The automatic switching execution condition may include a plurality of conditions. For example, a configuration is conceivable in which the automatic switching is executed when any one of the first condition that a large driving force exceeding the output limit of the motor 11 is required, and the second condition that the charge level SOC of the battery 12 is less than the predetermined value is satisfied. In such a case, the processing circuit 21 may be configured to perform the holding process only when a part of the plurality of execution conditions is satisfied. For example, among the first condition and the second condition, it is conceivable to configure the processing circuit 21 so that the holding process is executed when the automatic switching is executed when the first condition is satisfied, and the holding process is not executed when the automatic switching is executed when the second condition is satisfied. When the automatic switching is executed due to the establishment of the second condition, it is considered that the driver requires a large driving force. Therefore, in a case where the driver requests an increase in the driving force, it is possible to generate the driving force according to the request, and in a case where the driving force is not required, it is possible to suppress the deterioration of the emission.
The processing circuit 21 may also be configured to perform the holding process at the time of manual switching. Further, the switching from EV mode to HV mode may be performed by only one of the auto switching and the manual switching.

### Additional Remarks

### Appendix 1

The above-described embodiment and the above-described modification can be similarly applied to a hybrid electric vehicle having a configuration that differs from the above-described embodiment.

The control device for a hybrid electric vehicle according to any one of claims 1 to 3, wherein in the setting process, the processing circuit is configured to set an upper limit value of the traveling power in the electric traveling mode in accordance with a charge level of a battery that supplies electric power to the motor.

### Appendix 2

The control device for a hybrid electric vehicle according to claim 1 or 1, wherein, in the switching process, the processing circuit switches from the electric traveling mode to the hybrid traveling mode when a 1 condition in which a charge level of a battery for supplying electric power to the motor becomes less than a predetermined value is satisfied and a 2 condition in which a driver requests generation of a driving force exceeding a predetermined value is satisfied, and performs the holding process only when the 1 condition is satisfied among the 1 condition and the 2 condition.

What is claimed is:

1. A control device for a hybrid electric vehicle including two drive sources that are a motor and an engine, the control device comprising a processing circuit configured to perform:
a switching process for switching an electric traveling mode in which traveling is performed using only output of the motor and a hybrid traveling mode in which output of the engine is usable as traveling power;
a setting process for setting, in the electric traveling mode, an upper limit value of the traveling power to a value smaller than an upper limit value in the hybrid traveling mode; and
a keeping process for keeping the upper limit value of the traveling power at the value in the electric traveling mode during a period from the switching from the electric traveling mode to the hybrid traveling mode by the switching process to completion of catalyst warm-up of the engine.

2. The control device for the hybrid electric vehicle according to claim 1, wherein:
the switching from the electric traveling mode to the hybrid traveling mode by the switching process includes manual switching to be performed in response to a manual operation of a driver, and automatic switching to be performed automatically without the manual operation; and
the processing circuit is configured to perform the keeping process only when the automatic switching is performed out of the manual switching and the automatic switching.

3. The control device for the hybrid electric vehicle according to claim 2, wherein the processing circuit is configured to perform the automatic switching when a charge level of a battery that supplies electric power to the motor is smaller than a predetermined value in the switching process.
